(19) United States
(12) Patent Application Publication
(10) Pub. No.: US 2004/0237887 A1
(43) Pub. Date: Dec. 2, 2004

(54) Equipment for preparing for electrostatic painting three-dimensional articles with a predominantly flat extension

(76) Inventors: Silver Santandrea, Imola (IT); Stefano Beneditti, Borgo Tossignano (IT)

Correspondence Address: STITES & HARBISON PLLC, 1199 NORTH FAIRFAX STREET, SUITE 900, ALEXANDRIA, VA, 22314, US

(21) Appl. No.: 10/628,365

(22) Filed: Jul. 29, 2003

(30) Foreign Application Priority Data
Aug. 7, 2002 (IT) BO2002A000524
Apr. 24, 2003 (IT) BO2003A000243

(51) Int. Cl. B05C 5/00; B05B 5/025

(52) U.S. Cl. 118/621; 118/308

(57) ABSTRACT

The equipment for preparing for electrostatic painting three-dimensional articles (P) with a predominantly flat extension, made from dielectric or low-conductivity material, which move on and are supported by a horizontal conveyor (T), presents the feature that the conveyor is made from an electrically insulating material, having a resistivity greater than that of the panels (P) to be painted. One or more electrodes (E, 12) are placed in isolated positions, at suitable distances from each other and from the edges of the panels, under the said panels, at least while the powdered paints electrostatically charged to an electrical potential are being fed on to them. The electrodes emit an electrical field with characteristics such that it charges the whole visible surface of the said panels, as far as their area of contact with the conveyor, to an electrical potential of opposite sign to that of the powdered paints, in such a way that the powdered paints completely and uniformly cover the said visible surface of the panels.

The invention relates to machines for the electrostatic painting of three-dimensional articles having a predominantly flat extension, which are normally panels, made from dielectric or low-conductivity material, normally wood or wood derivatives, for example MDF, which move on and are supported by a horizontal conveyor, on which the said panels are charged to an electrical potential of opposite sign to that of the paint powders fed by the electrostatic guns into a chamber which is kept at negative pressure by suitable means. Machines of this type are described, for example, in documents WO 01/85357 A1 and EP 1 243 340 A2 (corresponding to U.S. application Ser. No. 10/101,845), to which the most wide-ranging reference will be made. In the first type of machine, the conveyor on which the panels move is made from electrically conductive material and comprises means for raising at least the upper run of the said conveyor to a specified electrical potential, for example a negative potential, with respect to earth, in such a way that the articles to be painted are also at this potential and can be painted on their visible surfaces by the paint powders fed into the paint chamber by the electrostatic guns which charge the said paints, to a positive potential for example. This solution has proved to be unsuitable for ensuring the electrostatic charging to a sufficiently and uniformly distributed electrical potential of the surfaces to be painted of articles with very low electrical conductivity, the main problems being encountered on the edges of the panels and particularly in their areas of contact with the conveyor, as if these areas were in electrostatic equilibrium or positively charged. In order to overcome this problem, the second of the aforesaid machines used a conveyor made of synthetic, and therefore electrically insulating, materials, having at least an outer surface which was a good conductor of electrical charges and using an electrostatic charging bar positioned transversely above and at an appropriate distance from the upper run of the said conveyor, and orientated with its points downwards, in such a way as to distribute electrical charges, of negative polarity for example, over the panel and over the conveyor passing beneath it, to charge them electrostatically with a specified polarity and intensity and in a uniformly distributed way before the conveyor and panel enter the paint chamber. This solution has also failed to provide the desired results on panels having very high resistivity, problems of coverage again being encountered at the edges of the panels and particularly in the areas of contact between the edges of the panels and the conveyor.

In various experiments conducted with the aim of overcoming the problem, the following solution yielded the desired results. The panel was placed on a surface made from an electrically insulating material, with a resistivity greater by at least one order of magnitude than that of the panel to be painted. Good results were obtained, for example, by using a porous polyethylene mat, such as one of the type used as a barrier in fluid beds, which is permeable to air but not to the paint powders, and which therefore incorporates air in its pores and consequently has an electrical behaviour very similar to that of air. A metallic electrode, connected to an electrically insulated conducting wire which passed through the mat and was connected to a source of negative electrostatic charges, was placed in a sufficiently centred position under the panel which rested on the insulating mat. The panel was then sprayed with paint powder charged positively by the electrostatic gun, and the result was surprising. The visible surface of the panel was covered completely and uniformly by the paint, even on the edges and in the areas of contact with the conveyor belt which had an unpainted area around the panel, in which the action of the electrical field generated by the electrode presumably ceased. It was subsequently found that the results deteriorated markedly if the electrode was very close to or very distant from one edge of the panel, and also in relation to the height of the said edge. If the panel was of considerable size in plan view, it could be acted on simultaneously by a plurality of electrodes, provided that these were positioned at sufficient distances from each other and from the perimeter of the said panel.

Three possible ways of implementing the aforesaid solution on an industrial scale were identified. The electrodes can be positioned under the upper run of the conveyor and can be operated selectively according to the dimensions of the panels to be painted. In another solution, the electrodes are again under the active run of the conveyor and are mounted in a movable way on means which enable the said electrodes to follow the panel during the painting and to be connected selectively to a fixed polarization source. Finally, in another solution the electrodes are embedded in the conveyor, in such a way that their upper ends are very close to the panel or directly in contact with it, so that they accompany it in its movement and interact selectively, by means of their lower ends or by means of an electrical conductor associated with them, with a fixed or movable polarisation collector. Further characteristics of the invention and the advantages derived therefrom will be made clear by the following description of some preferred embodiments of the invention, illustrated purely by way of example and without restrictive intent in the figures of the attached sheets of drawings, in which:

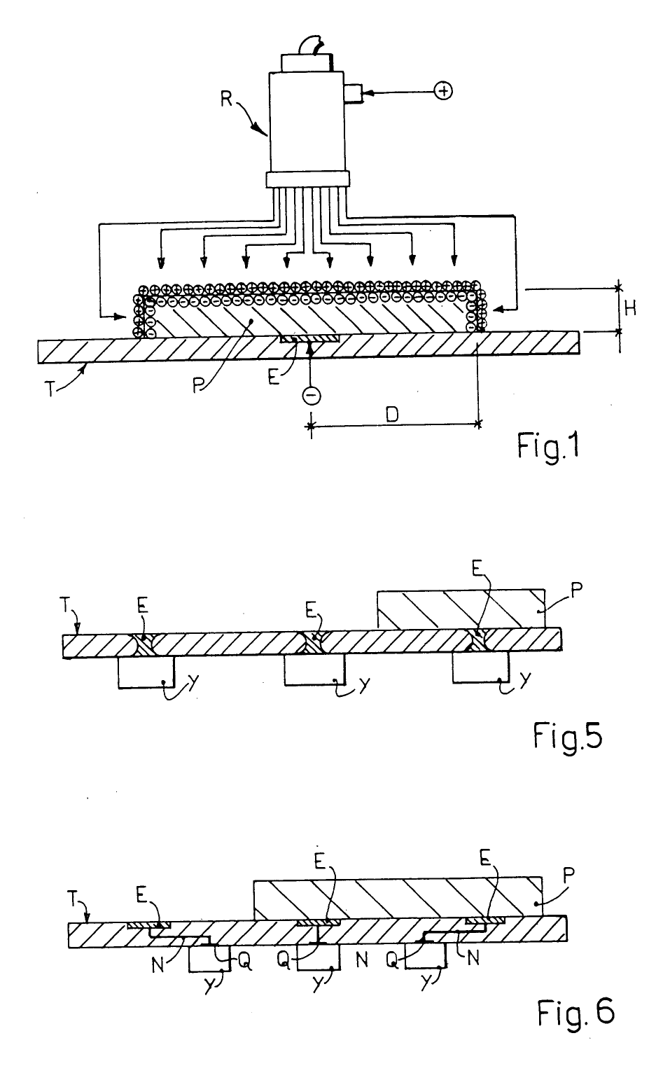

FIG. 1 shows schematically the method of constructing the conveyor and positioning the electrode in relation to the panel to be painted;

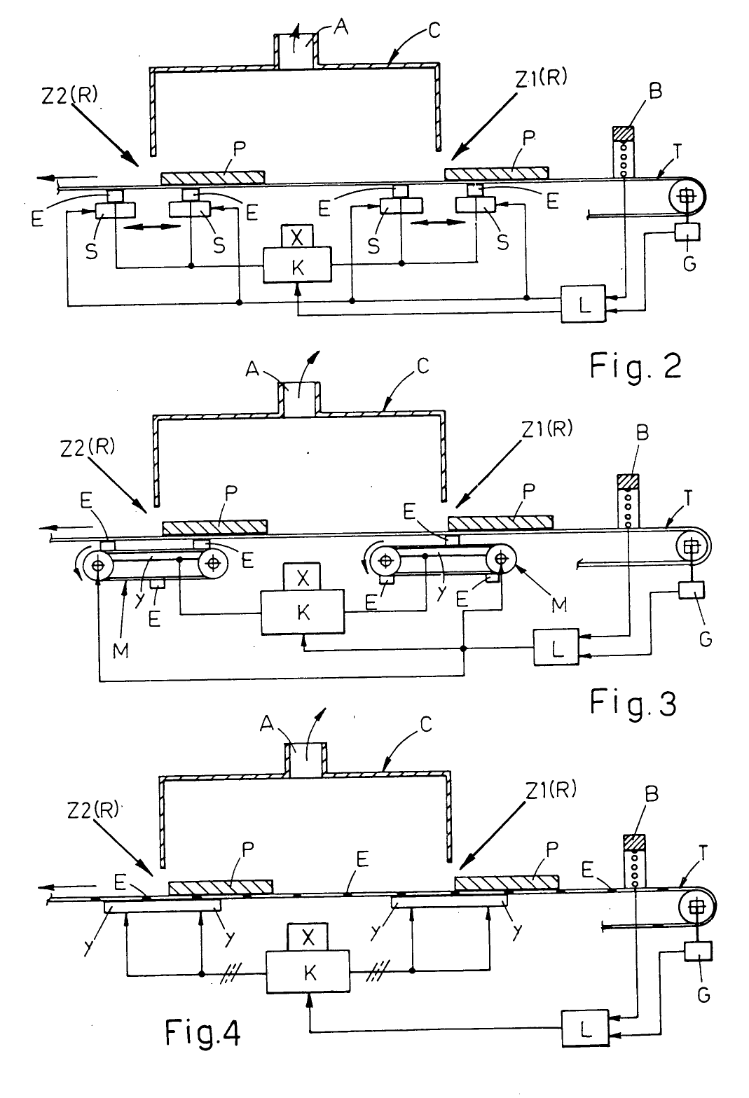

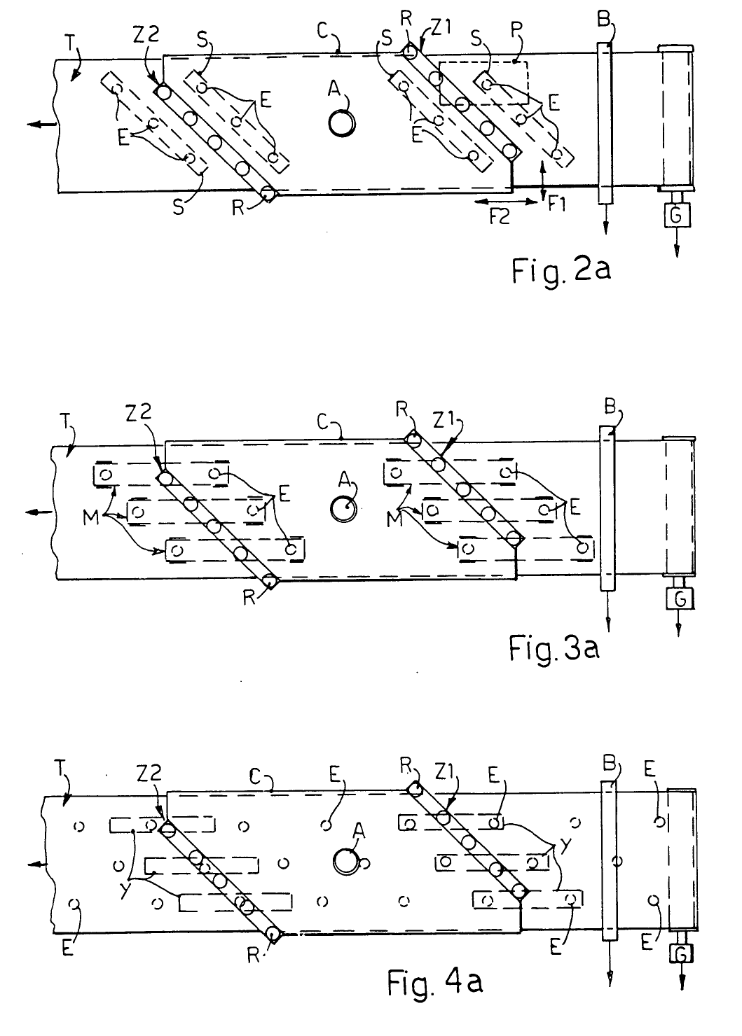

FIGS. 2, 3, 4 and 2a, 3a, 4a show schematically, in lateral elevation and in plan view respectively, the same number of other possible embodiments of equipment for the practical application of the method of FIG. 1;

FIGS. 5 and 6 show a cross section through the conveyor of the solution of FIGS. 4 and 4a, in different possible embodiments;

FIG. 7 is a schematic plan view of the painting machine in a version with movable electrodes;

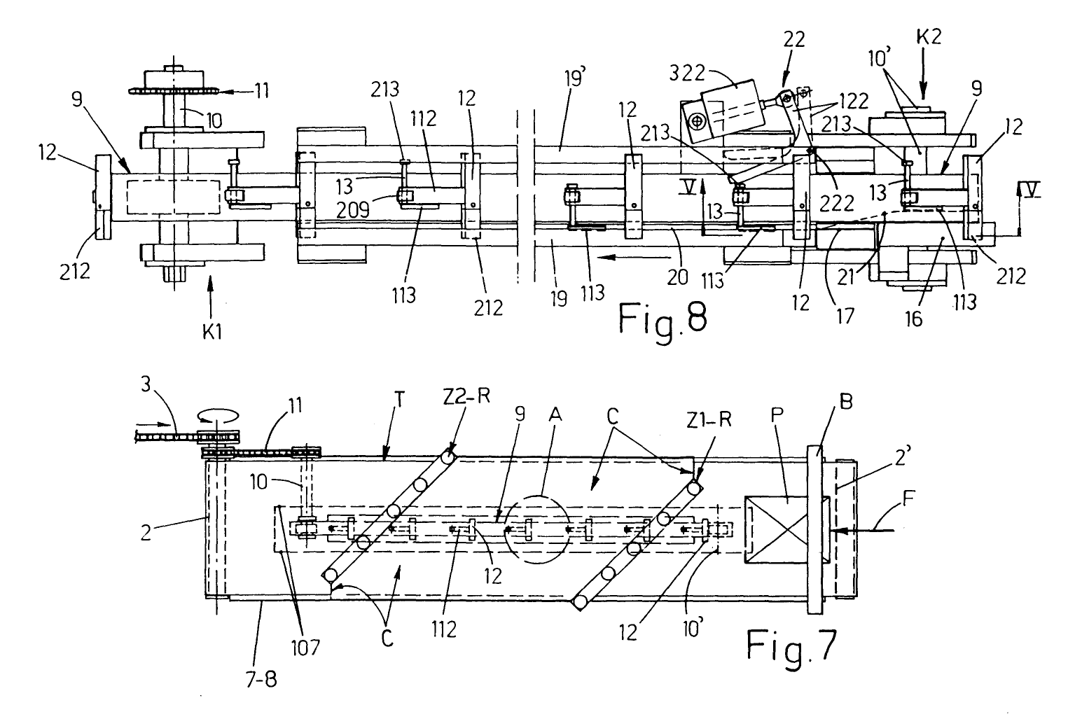

FIG. 8 is a plan view from above of the upper run of the conveyor with the electrodes of the machine of FIG. 7;

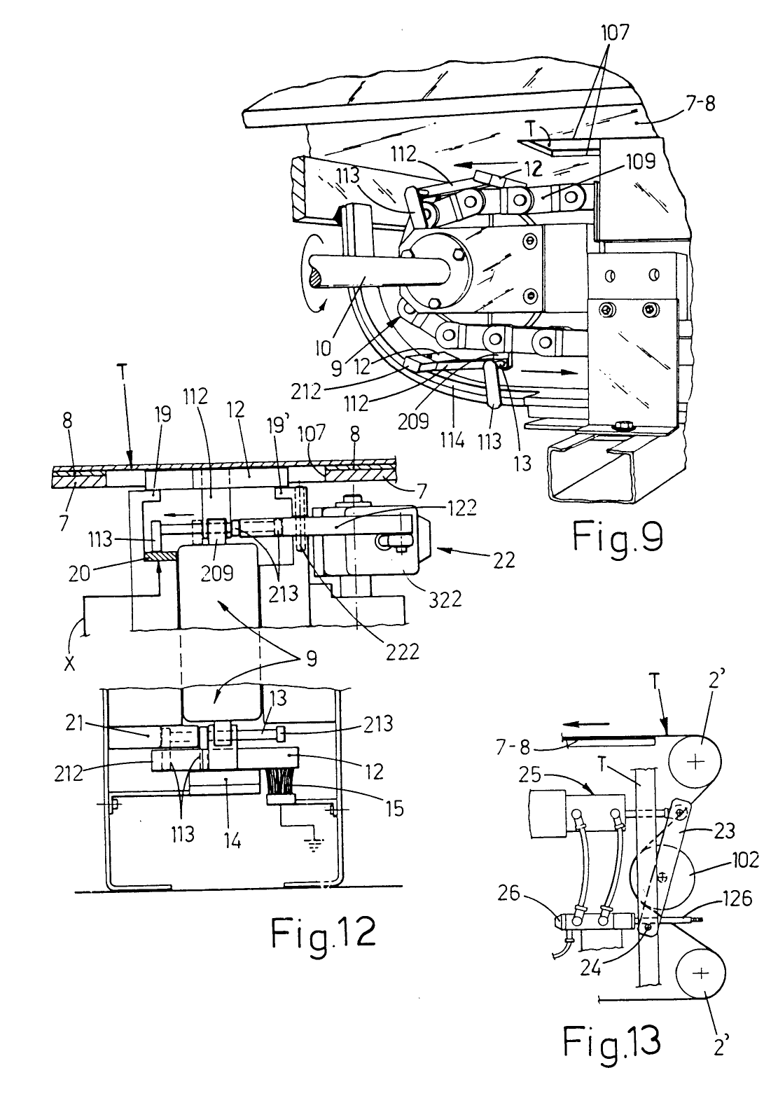

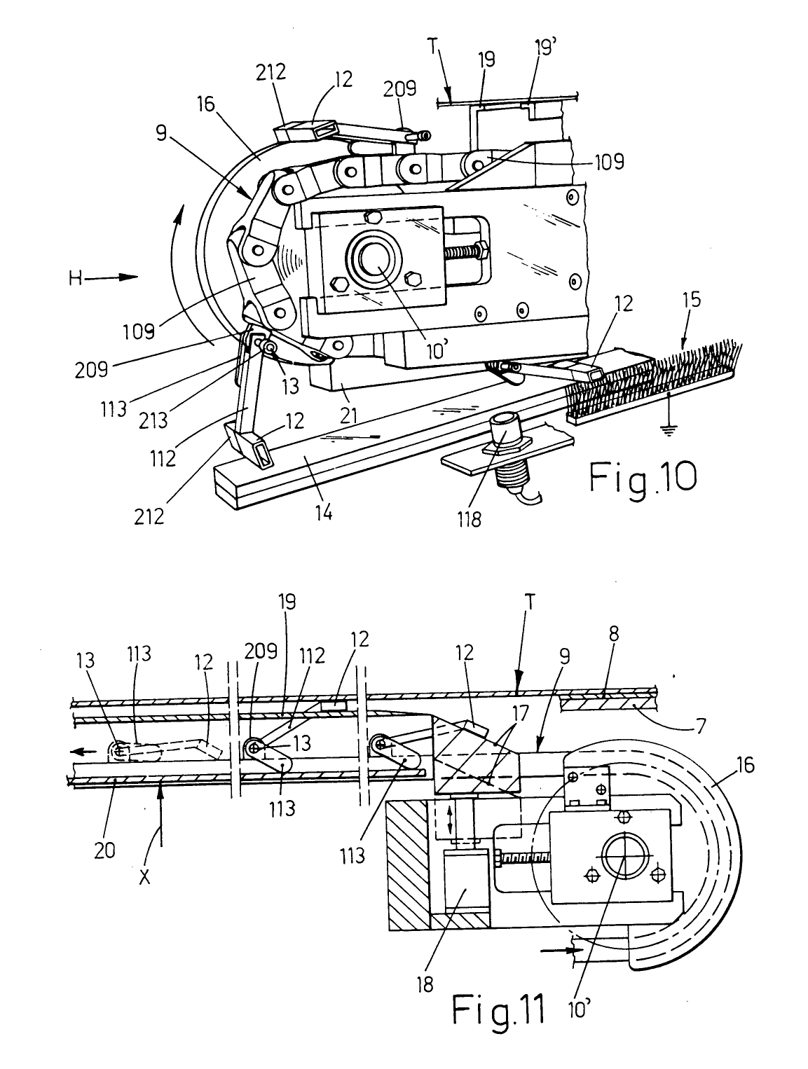

FIGS. 9 and 10 are perspective views of the final and initial ends respectively of the conveyor of FIG. 8, seen from the sides indicated by the arrows K1 and K2 respectively;

FIG. 11 shows other details of the conveyor of FIG. 8, in a section taken along the line XI-XI;

FIG. 12 is a front elevation of the initial end of the electrode conveyor, viewed in the direction of the arrow H in FIG. 10;

FIG. 13 is a side elevation of the details of the idle guide and return rollers of the conveyor belt of the painting machine;

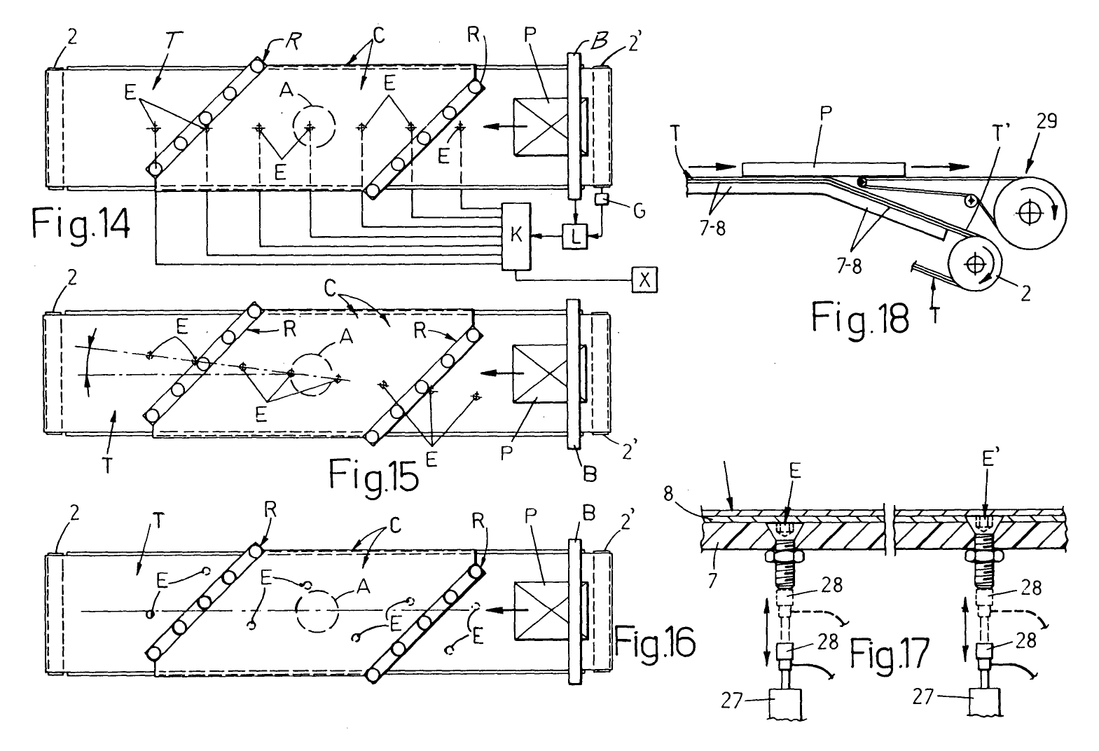

FIGS. 14, 15 and 16 are plan views from above of the same number of different embodiments of a painting machine with fixed electrodes;

FIG. 17 is a lateral view, in partial section, of the details of the positioning of the polarization electrodes of the machine shown in FIGS. 14 to 16;

FIG. 18 is a lateral view of a possible embodiment of the terminal part of the panel movement conveyor in the machine with fixed electrodes.

FIG. 1 shows how, according to the invention, the conveyor T, which supports the panels P to be painted, is to be constructed from any material or set of materials having characteristics of electrical insulation, having at least in the area in contact with the panel P an electrical resistivity which exceeds that of the said panel (e.g. 1011) by at least one order of magnitude (e.g. 1012). All the supporting and guiding parts of the conveyor T are obviously earthed as in the prior art. The conveyor T can be made wholly or partially from polyethylene and preferably from a material which is sufficiently porous to be permeable to air and not to paint, in other words in order to improve the resistivity of this material further, and also in order to enable pressurized air to be blown through the return run of the conveyor T to provide more thorough cleaning of the belt than that obtainable by the usual means of known types. This solution is not illustrated in the drawings since it is easily understood and can be implemented by persons skilled in the art on the basis of the explanations given previously. The thickness of the conveyor belt T can vary according to the positioning of the electrodes E, as described more fully below. Under the panel P there is positioned an electrode E of any suitable shape, connected to the source provided for the polarization, for example negative polarization, of the visible surface of the said panel on to which the paint powder is fed by the electrostatic guns R which charge the paint to a positive potential, so that it adheres completely and uniformly to the panel. It has been found that, in order to obtain the best results, the electrode E must be positioned at a distance D from the edges of the panel which is greater than 1-2 times the height H of the said panel and less than or equal to approximately 10 times the said height H. If the panel is of considerable size or has an elongate shape, it can be acted on simultaneously by a plurality of electrodes, provided that these are spaced apart by distances such that they do not interfere with each other, for example by distances of not less than approximately 10 times the height H of the edge of the panel. The electrode E can have any shape, for example round or square, or can be star-shaped with a plurality of points positioned in a flat arrangement or with a single point converging towards the panel, to exploit the shape of the electrical fields emitted by point electrodes. The electrodes E can be made from metal, from conducting rubber and/or from other materials suitable for the purpose.

FIGS. 2 and 2a show schematically an electrostatic painting machine of the type referred to, having a horizontal conveyor belt T of the aforesaid type, whose upper run passes through a paint chamber C having at least one suction duct A and having entry and exit doors Z1 and Z2 which are, for example, oblique and staggered with respect to the transverse dimension of the belt T, near to which doors the guns R for feeding the paint powders operate. The electrodes E for the electrical polarization of the panels P to be painted are positioned under the upper run of the conveyor T which in this case will be made at least partially with a thickness such that the effects of the electrodes are not attenuated. The electrodes can be fixed and are connected to the electrical polarization source X through a switch unit K controlled by a processor L which receives from an encoder G the data relating to the speed of movement of the conveyor T and which receives from an optoelectronic barrier B the data relating to the shape and dimensions of the panels P, in such a way that the said electrodes E are activated selectively according to the dimensions of the panels to be painted and their spatial positioning in the painting machine. The electrodes E of the solution of FIGS. 2 and 2A can be mounted on motorized sliders S so that they move, under the control of the processor L, transversely or longitudinally with respect to the belt T, for example as shown by the arrows F1 and F2, in order to automatically match their positions to the changes in the dimensions and positioning on the belt of the panels P to be painted. There is no reason why the movability F2 in the longitudinal direction should not be used to make the electrodes E accompany the panel in its passage, with or without relative movement with respect to the conveyor T, and then return to operate correctly on the following panel. A similar alternative to this last solution is shown more fully in FIGS. 3 and 3a, in which the electrodes E are shown to be mounted on conveyors M positioned under the upper run of the conveyor T and running in phase with the latter, in the same direction and at the same speed or with an exact degree of slip, in such a way that at least one electrode E is always positioned under the panel P which is passing on the said conveyor T, in such a way that the electrode is always at the correct distance from the edges of the said panel. The electrodes of the conveyors M are connected to the power source K by means of sliding collectors Y or other suitable collectors whose nature will be evident to those skilled in the art. A plurality of conveyors M can be provided adjacently to each other and means can be provided to enable the transverse positioning of the said conveyors with respect to the main belt T to be modified automatically with changes in the dimensions of the panels to be painted, again under the control of the processor L.

In the solution shown in FIGS. 4 and 4a, the electrodes E are integral with the conveyor T, move with the latter and with the panels P to be painted, and receive the requisite power by interaction with collectors Y, of the fixed type for example, connected to the switching point K for selective power supply. The electrodes E can be, for example, of the type illustrated in detail in FIG. 5, incorporated in the thickness of the conveyor T, and made for example from metal or conductive rubber, with their upper ends exposed in such a way that they touch the panel P and with their lower ends interacting with the collector Y by sliding along it. In the other solution shown in FIG. 6, the electrode E can be made from conductive rubber or metal, is fixed on the upper face of the conveyor T by any means in such a way that it touches the panel P directly or through a small protective element which provides structural continuity to the visible face of the conveyor T while also facilitating the cleaning of the conveyor, and the said electrode is connected to an electrically protected conductor N inside the conveyor T, connected to a contact Q fixed on the lower face or to another suitable point of the conveyor T, the contacts Q of the various electrodes being aligned in a plurality of tracks for interaction with corresponding collectors Y, in such a way as to provide a selective power supply to the electrodes according to the dimensions of the panels to be painted. There is no reason why, in the solution considered above, the collectors Y should not be movable instead of fixed, or arranged to move in a reciprocating way in the direction of the length of the conveyor T.

In the examples illustrated in FIGS. 2, 3, 4 and 2a, 3a, 4a, it is assumed that the electrodes E operate at least at the entry door Z1 and exit door Z2 of the paint chamber C, where the paint guns R operate, but it is to be understood that, possibly for the purposes of simplifying the construction of the machine, the range of activity of the electrodes can be wider and distributed over a larger area than that shown, up to the point where they act on the whole or practically the whole length of the upper run of the conveyor T (see below).

Further improvements to the machine according to the invention will now be illustrated with reference to FIGS. 7 to 18. In FIG. 7, the letter T indicates the horizontal belt conveyor on which the panels P to be painted are arranged, this conveyor running on end rollers 2 and 2′, one of which is connected to a motive power source 3 which makes the said conveyor advance, for example, in the direction indicated by the arrow F, with a continuous movement and at a specified speed. The panels P pass through the optoelectronic barrier B or other suitable means which, as stated above, detects its dimensions and its position in space and which controls the operation of the means for electrostatically charging the said panels and the starting and stopping of the operation of the electrostatic paint guns R which operate at the entry and exit doors Z1, Z2 of the paint chamber C.

For the resolution of the problem relating to the electrostatic charging of the panels P to be painted, even where these are made from MDF or other material with high electrical resistivity, good results have been obtained by using a belt conveyor T formed from a polyester fabric core impregnated with polyurethane and coated with polyurethane on the upper face at least, so that it has a perfectly smooth outer surface which is particularly suitable for cleaning by mechanical and pneumatic means of known types (not shown) which operate at the position of the return roller 2. The total thickness of the belt T is approximately 0.8 mm, inclusive of the polyurethane layer which is approximately 0.2 mm.

FIGS. 7, 11, and 12 show how the upper run of the conveyor T slides along and is supported by a horizontal bed 7 supported by the frame of the machine and having a longitudinal aperture 107 which leaves free the corresponding longitudinal strip of the said conveyor T on which the electrodes for polarizing the panels P are designed to act, as described above. Good results have been obtained by making the bed 7 from polypropylene and/or any other electrically insulating material which has a resistivity greater than that of MDF. The direct friction of the belt T on the polypropylene 7 bed gave rise to charges which caused unpredictable behaviour of the paint powder deposited on the said conveyor belt T. This problem was overcome by placing between the polypropylene surface 7 and the belt T a sheet 8 of the material used to form the said belt T, fixed in a convenient way on the underlying surface 7.

FIGS. 7 to 12 show how a rectilinear conveyor 9, aligned longitudinally with the conveyor T and having the shafts 10 and 10′ of its return sprockets horizontal and parallel to the shafts 2 and 2′, operates in the aperture 107 of the bed 7. The shaft 10 is connected by a positive transmission of motion 11 to the motive power source 3, in such a way that these conveyors T and 9 move in the same direction F and at the same speed. In a variant construction which is not shown, the longitudinal axis of the conveyor 9 can be slightly inclined with respect to that of the conveyor T. The conveyor 9 is formed from a chain of links 109 (FIGS. 9 and 10) of electrically insulating material, which carry, at constant intervals which are preferably decimal, for example of the order of approximately ten to twenty centimetres, projecting appendages 209, also made from electrically insulating material, on which are pivoted the forked ends of metal levers 112, each of which carries a head 12 forming an integral part of the lever and positioned transversely at the opposite end, this head 12 forming the actual electrode for polarizing the panels, which is also made from metal, is formed for example from a length of a tubular metal shape with a rectangular cross section, having dimensions of approximately 20×10×65 mm and orientated in such a way that, as it passes along the upper run of the conveyor 9, if the electrode is in the high position and active, the said head 12 touches the lower face of the conveyor T uniformly with one of its larger faces measuring 65×20 mm. The lever 112 is pivoted on the supporting appendage 209 by means of a metal pin 13 which is freely rotatable (see below), and which carries a small lever 113, integral with the appendage or rotatable, at one end, this lever constantly tending to point downwards under the action of gravity or of elastic means. FIGS. 9, 10 and 12 show how, as the electrodes 12 travel along the lower run of the conveyor 9, they slide along a fixed guide 14 whose area in contact with the said electrodes is made from electrically insulating material, the curved end portion 114 of this guide (FIG. 9) collecting the electrodes as they leave the upper run of the conveyor 9, in order to prevent them from swinging in an unnecessary and dangerous way and to position the said electrodes so that in the final part of their inactive travel they interact with a metallic brush 15 which is connected to earth and which discharges any residual potential difference from them. Each electrode 12 carries on at least one end an integral skid 212 of electrically insulating material with a low coefficient of friction, which, during the return to the end shaft 10′ of the conveyor 9, interacts with a fixed guide in the form of a sector of a circle 16 (FIG. 11) which keeps the electrodes away from the links of the chain of the said conveyor, to ensure that these links are free to move relatively to each other. FIG. 9 shows how an inclined-plane cam 17 is provided in the initial part of the upper run of the conveyor 9, forming a continuation of the curved guide 16, this cam being transferable by an actuator 18 from the raised position indicated in solid lines to the lowered position indicated in broken lines, at the command of the processor which controls the operation and which, additionally using the data received from the barrier B, determines whether or not the electrodes cyclically reaching the high position are to be activated. A sensor 118 visible in FIG. 10 detects the phase of the electrodes and transmits this useful information to the aforesaid processor. If an electrode 12 is to be activated, the cam 17 is in the high position and interacts with the end skid 212 of the electrode which reaches it, this electrode being progressively raised and brought into contact with the lower face of the belt T. Immediately downline from the cam 17 in the high position there is provided the initial part, tapered to form a suitable lead-in, of a linear guide 19, preferably made from electrically insulating material, which is fixed to the frame of the conveyor in question, parallel to the longitudinal axis of the said conveyor, and which keeps the electrode in contact with the conveyor belt T. FIG. 12 shows how another fixed guide 19′, also made from electrically insulating material with a low coefficient of friction, is preferably provided opposite and parallel to the guide 19, the electrodes 12 sliding and bearing directly on the guide 19′ in order to ensure that these components are positioned in a perfectly horizontal way with a uniformly distributed constant contact with the conveyor T above them. It is to be understood that, in a variant construction which is not shown, the end of each electrode 12 designed to interact with the fixed guide 19′ can also be provided with a skid of electrically insulating material with a low coefficient of friction, similar to the skid 212. It is also to be understood that rollers can be provided in place of these skids for a rolling interaction with the said guides 19 and 19′.

If, on the other hand, one of the electrodes 12 must not operate in contact with the belt T, then when this component leaves the curved guide 16 the cam 17 is in the low position shown in broken lines in FIG. 11, and therefore the electrode 12 continues to bear on the electrically insulating links of the conveyor chain 9, as shown in broken lines on the left of the said FIG. 11. The electrode in the low position is at a distance from the conveyor T which can be sufficient to prevent any effects on the panels P above it, even if the said electrode is live. During its travel along the upper run of the conveyor 9, the lever 113 pivoted on the fulcrum pin 13 of the lever with the electrode 12 is orientated downwards by gravity, and its rounded end bears on and slides along a linear metal collector 20, which is located under the aforesaid guide 19 and fixed on the electrically insulating section forming this guide, and which is connected to the electrical generator for polarizing the electrodes, shown schematically in FIGS. 11 and 12 by the arrow X. The generator X can generate a continuous voltage which can vary, for example, from 0 to 100 kV, with a useful value of approximately 60 kV and a current measurable in microamperes, for example approximately 500 A.

Since the distance of the electrodes 12 in the low inactive position, shown in broken lines on the left of FIG. 11, might be insufficient to neutralize the electrical effects of the said electrodes on the panels above them, provision has been made for the selective control of the contact of the levers 113 with the polarization collector 20, only in the case of the electrodes which are to be active. For this purpose, the pins 13 are axially movable and each has a head 213 at the opposite end from the lever 113. FIGS. 8, 10 and 12 show how, before leaving the lower run of the conveyor 9, the end of each pin 13 carrying the lever 113 which has previously left a stage of interaction with the upper collector 20 interacts with a linear fixed cam 21 of electrically insulating material, which forces the said pins to move axially and thus bring the lever 113 closer to the supporting appendage 209, so that, on their curved trajectory around the end shaft 10′ of the conveyor 9, all the levers 113 bear on the links 109 of this conveyor, and when they reach the upper branch are located on a trajectory which is out of alignment with the linear collector 20 and is at a sufficient distance from it (FIGS. 8 and 12). The same figures show how there is provided in the initial part of the upper run of the conveyor 9 an exchange device 22 which, when commanded by the processor controlling the machine, axially moves the pins 13 of only those electrodes which are to continue in the high active position, the lever 113 of these pins being moved to the trajectory on which the polarization collector 20 lies. The exchange device comprises a right-angled lever 122 pivoted at 222 on a vertical axis and connected to an oscillation actuator 322 which, on command, can move the said lever from the resting position shown in broken lines, in which it does not interfere with the pins 13, to the active position shown in solid lines, in which one arm of this lever is inclined so that it interferes with the heads 213 of the pins 13 to subject them to the necessary axial movement for activating the corresponding contact lever 113.

Since the conveyor belt T is very thin, it is highly flexible and relatively elastic, and is therefore sensitive to the resistances which it encounters during its advance, which are not balanced and symmetrically distributed, so that the said conveyor tends to slip sideways and means are required to keep it automatically on track. FIG. 13 shows how these means comprise the running of one end of the belt T, preferably the driven end, over a pair of static parallel rollers 2′, one above the other, supported rotatably by the fixed frame 1 of the machine, and over a third roller 102 located between the preceding ones (or down-line from the roller 2′) and parallel to these, such that the belt T is made to form a re-entrant bend. The roller 102 is mounted rotatably with each of its ends on the intermediate part of a lever 23 which has one end pivoted at 24 on the fixed frame 1 of the machine and the other end connected to an oscillation actuator 25, of the pneumatic type for example, coupled to a command circuit with the interposition of a unit 26 having a feeler 126 which senses the position in space of the side of the conveyor T next to the lever 23. If the conveyor T slips outwards, it causes the feeler 126 to bend outwards and consequently causes the switching of the unit 26 which temporarily retracts the rod of the actuator 25 on a predetermined path which returns the conveyor T to its track. The pressure on the feeler 126 is progressively reduced, causing the unit 26 to switch again so that the actuator 25 returns to the resting position.

It is to be understood that, if the belt conveyor T has a width such that it can accommodate panels of considerable width, a plurality of conveyors 9 with the corresponding electrodes 12 can be positioned side by side and in a parallel arrangement under the upper run of the said conveyor T, and means will be provided to selectively operate these conveyors 9 or their electrodes 12, according to the dimensions of the panels to be painted.

In the painting machine with fixed electrodes, as shown in FIGS. 2 and 2a, it is assumed that the polarization electrodes E are located only at the entry and exit doors of the paint chamber, where the paint spray guns operate. Practical tests have shown that, in order to ensure uniformity and stability of coverage of the panel with the paint, it is preferable for the panel to remain suitably polarized by the electrodes for the whole of its passage through the paint chamber. For this purpose, in a painting machine with a conveyor T having the characteristics described above, with an upper run sliding on a horizontal bed 7-8 having the characteristics described above, but able to be structurally continuous, without the aforesaid longitudinal aperture 107, the electrodes E are fixed on this bed and are positioned at isolated points aligned in at least one row having a length suitably greater than that of the paint chamber C and aligned with the longitudinal axis of this chamber, as in the example shown in FIG. 14. The electrodes are suitably spaced apart from each other, for example at intervals of 5 to 20 times, for example approximately 10 times, the height of the edges of the panels to be painted. In the variant shown in FIG. 15, the row of electrodes E can be positioned with a slight inclination with respect to the longitudinal axis of the conveyor T, for example with an inclination in the range from 0° to 15°, for example approximately 7°, in such a way that the electrodes are placed progressively in different positions with respect to the edges of the panels, to ensure a correct and uniform coverage of the panels with paint. Also for this purpose, the electrodes E can be positioned differently on the vertices of a broken line which forms an alternating wave as in the case of FIG. 16, with the horizontal axis suitably inclined with respect to the longitudinal axis of the conveyor T, in such a way that the said electrodes have a wider spatial distribution than that shown in FIG. 15.

It is to be understood that, if the machine with fixed electrodes is to operate on very wide panels, a plurality of rows of electrodes can be positioned side by side, with a distance between the electrodes of one row and those of the neighbouring row not less than the distance between the electrodes in a single row and/or with any necessary staggering between the electrodes of one row and those of the adjacent row. The various rows of electrodes are connected to selective activating means, controlled for example by the entry barrier B, in such a way that they are activated selectively and automatically in accordance with the dimensions of the panels P to be painted.

The detail in FIG. 17 shows how the electrodes E can be made in the form of screws with flat countersunk heads, with hexagonal sockets, and with shanks of suitable diameter, from 5 to 15 mm for example, fixed in holes formed in the bed 7, in such a way that the flat faces of their heads are positioned to be coplanar with the upper face of the said bed 7, as in the case indicated by E and shown on the left of FIG. 17, or coplanar with the covering 7 of the said bed and thus essentially in contact with the lower face of the conveyor T, as in the case indicated by E′ and shown on the right of FIG. 17. The shank of each of the screws forming the electrodes projects beneath the bed 7, interacts with a fixing nut and can be connected in any suitable way to the polarization generator. Good results have been obtained by permanently connecting all the electrodes of one row to the polarization generator. However, better results have been obtained by modulating the activation and inactivation of the electrodes of each row, according to the variations of the position above them of the panel to be painted, which moves continuously, in such a way that the electrodes, when activated, are never at critical distances from or too close to the edges of the panels. For this purpose, as shown in FIG. 14, the electrodes can be connected selectively to the polarization source X through a switch unit K controlled by a processor unit L which receives from the barrier B and from an encoder G the data relating to the dimensions and speed, and therefore to the position in space, of the panels to be painted. The switch unit K can comprise static electronic switches, or can control dynamic switches, consisting for example of small cylinder and piston units 27 as shown in the detail of FIG. 17, located under the screws which form the electrodes E, having their rods aligned and orientated against these screws and holding, with the interposition of an insulating support, an electrical contact 28 connected to the polarization unit X. In this case, the cylinders 27 are operated selectively, through a suitable interface, by the process unit L shown in FIG. 14, the whole system being understandable and easily constructed by persons skilled in the art.

Finally, in painting machines of the type under discussion, it has been found that the powdered paint deposited on the conveyor may fly upwards at the discharge end of the support bed 7-8, owing to the perturbation of an electrostatic equilibrium caused by the interruption of the said bed and/or unfavourable ambient atmospheric conditions and/or the characteristics of the various paint powders used from time to time, thus adversely affecting the correct placing of the paint on the edges of the painted panel, particularly on the front and rear edges. To overcome this problem, use can be made of the solution shown schematically in FIG. 18, in which the terminal part T′ of the conveyor T is inclined downwards and continues to be supported by the bed 7, 8. Above this final inclined portion T′ of the conveyor T there is provided a wedge-shaped conveyor 29 of suitable material, whose upper run is coplanar with and immediately consecutive to the horizontal run of the said conveyor T and which advances in such a direction and at such a speed that it collects and removes the painted panel, the whole being arranged in such a way as to overcome the aforesaid problems. Suitable means, not shown, are provided to clean the paint off the conveyor 29 as well.

1) Equipment for preparing for electrostatic painting three-dimensional articles (P) with a predominantly flat extension, made from dielectric or low-conductivity material, which move on and are supported by a horizontal conveyor (T), characterized in that the conveyor is made from an electrically insulating material, having a resistivity greater than that of the panels (P) to be painted and characterized in that one or more electrodes (E, 12) are placed in isolated positions, at suitable distances from each other and from the edges of the panels, under the said panels, at least while the powdered paints electrostatically charged to an electrical potential are being fed on to them, the electrodes emitting an electrical field with characteristics such that it charges the whole visible surface of the said panels, as far as their area of contact with the conveyor, to an electrical potential of opposite sign to that of the powdered paints, in such a way that the powdered paints completely and uniformly cover the said visible surface of the panels.

2) Equipment according to claim 1, in which the conveyor (T) is made from a sufficiently porous material, permeable to air but not to the paint powders.

3) Equipment according to claim 2, characterized in that the lower return run of the conveyor (T) is cleaned not only by conventional methods but also with a jet of pressurized air which passes through the said return run from the interior to the exterior, suction means being provided opposite these means to collect and remove the dust resulting from this cleaning operation.

4) Equipment according to claim 1, in which the conveyor (T) is made, at least in the part in contact with the panels (P) to be painted, from a material whose resistivity is greater by at least one order of magnitude than that of the said panels.

5) Equipment according to claim 4, in which the conveyor (T) is made wholly or partially from polyethylene.

6) Equipment according to claim 1, in which the electrode (E) for polarizing the panel to be painted is located at a distance from the edge of the said panel which is greater than 0.5 to 4 times, and preferably greater than 1 to 2 times, the height (H) of the edge of the said panel (P).

7) Equipment according to claim 1, in which the electrode (E) for polarizing the panel to be painted is located at a distance from the edge of the said panel which is not more than 5 to 20 times, and preferably not more than approximately 10 times, the height (H) of the edge of the said panel (P).

8) Equipment according to claim 1, in which, when the shape of the panels (P) is such that they have to be acted on by a plurality of electrodes (E), the distance between the said electrodes is not less than 5 to 20 times, and preferably not less than approximately 10 times, the height H of the edge of the said panel (P).

9) Equipment according to claim 1, in which the electrodes (E) are of any suitable shape for their intended purpose, are fixed with a precise distribution to the conveyor (T) so that they are as close as possible to or directly in contact with the panel to be painted, and are connected, by means of extensions or by means of electrical conductors (N) connected to them, to corresponding fixed contacts (Q) connected to the lower face and/or to the edges of the conveyor, where the said contacts are distributed in rows for interaction with the power supply collectors (Y) which are supplied selectively, according to the dimensions of the panels to be painted, by at least one switching unit (K) connected to the electrical generator (X).

10) Equipment according to claim 9, in which the collectors (Y) and the switching and power supply units (K, X) are fixed.

11) Equipment according to claim 9, in which the collectors (Y) are movable with forward and return reciprocating movements in the direction of the movement of the panels to be painted.

12) Equipment according to claim 1, in which the electrodes (E) are of any suitable shape for their intended purpose and are positioned under the upper run of the conveyor (T) for advancing the panels to be painted, the thickness of the conveyor being reduced in order to cause the least possible attenuation of the electrical field generated by the said electrodes which are located at least near the painting unit or units (R) and can be connected selectively to the electrical generator (X) through at least one switching unit (K), in such a way that they can be activated selectively, at least in accordance with the dimensions in plan view of the panels to be painted.

13) Equipment according to claim 12, in which the electrodes (E) are mounted on motorized sliders (S) by means of which their position can be adjusted in space, for better adaptation to the dimensions in plan view of the panels to be painted.

14) Equipment according to claim 12, in which the electrodes (E) are fixed.

15) Equipment according to claim 12, in which the electrodes (E) are mounted on structures by means of which the said electrodes can be given a cyclical forward and return movement in the direction of the movement of the panels to be painted.

16) Equipment according to claim 15, in which the said means of movement are means (S) of reciprocating rectilinear movement.

17) Equipment according to claim 15, in which the said means of movement are means (M) of continuous movement of the closed conveyor type and the electrodes are connected to the switching and power supply source (K, X) by means of collectors (Y) of the sliding contact or other suitable type.

18) Equipment according to claim 12, in which means are provided for controlling the operation of the electrodes in accordance with the dimensions and the positioning in space of the panels to be painted and these means comprise a switching unit (K) connected to the electrical polarization generator (X) and controlled by a processor (L) which receives the information on the dimensions of the panels from optoelectronic means (B) located up-line from the paint chamber (C) and which receives from an encoder (G) the information on the speed of advance of the conveyor (T), means being provided to enable the said processor to operate with access to the information on the position in space at any moment of the panel to be painted.

19) Equipment according to claim 1, characterized in that the belt conveyor (T) for advancing the articles to be painted has a thickness which is restricted as much as possible and is in the range from 0.5 to 3 mm, for example approximately 0.8 mm.

20) Equipment according to claim 19, in which the belt conveyor (T) is formed from a polyester fabric core or equivalent material, impregnated with polyurethane or equivalent material, and is coated at least on its upper face with polyurethane or equivalent material, in such a way that it has a perfectly smooth outer surface which is particularly suitable for cleaning with mechanical and pneumatic means which operate according to the prior art on the return run of the belt conveyor.

21) Equipment according to claim 20, in which the polyurethane layer is approximately 0.2 mm thick.

22) Equipment according to claim 19, in which the upper run of the conveyor belt (T) slides on and is supported by a flat horizontal bed (7) supported by the frame of the machine and made, for example, from polypropylene and/or any electrically insulating material, which has a resistivity greater than that of MDF and which is coated on the face in contact with the said conveyor belt (T) with at least one sheet (8) of the same material as that of the belt (T).

23) Equipment according to claim 19, in which the electrodes (12) are mounted at equal distances from each other and in such a way that they can be activated and de-activated, on one or more rectilinear closed conveyors (9) of the horizontal axis type, which are made from electrically insulating material, are positioned longitudinally under the upper run of the said belt conveyor (T), move in the same direction and at the same speed as this conveyor (T), and have a length such that they follow the panels positioned above them throughout the painting cycle.

24) Equipment according to claim 23, in which the conveyor (9) of the electrodes takes its motion from the transmission system (3) which also drives the belt conveyor (T) of the painting machine.

25) Equipment according to claim 22, in which the bed (7, 8) supporting the upper run of the conveyor (T) has at least one longitudinal aperture (107) which leaves free the portion of the said conveyor on which the electrodes (12) for polarizing the articles to be painted (P) can act by contact.

26) Equipment according to claim 22, in which the conveyor (9) which carries the electrodes is formed from a chain of links (109) of electrically insulating material, which carry at constant intervals projecting appendages (209), also made from electrically insulating material, on which are pivoted by their forked ends metal levers (112) each of which carries integrally and transversely on its other end a metal head (12) which forms the actual electrode for polarizing the panels, the said lever (112) being pivoted on the said supporting appendage (209) by means of a freely rotatably metal pin (13) which has at one end a small lever (113) which terminates in a rounded end and which is constantly orientated downwards by gravity or by the action of suitable means and which while travelling along the upper run of the conveyor in question slides on a linear metal collector (20) connected to the voltage generator (X) for the necessary polarization of the electrodes.

27) Equipment according to claim 23, in which the electrodes attached to the conveyor (9) are spaced apart from each other at decimal intervals, for example 10 to 20 cm.

28) Equipment according to claim 26, in which the metal head (12) of the said oscillating metal lever (112), which forms the actual electrode, is for example formed from a length of tubular section with a rectangular cross section, orientated in such a way that, as it travels along the upper run of the conveyor (9), if the electrode is to be in the high active position, the said head (12) uniformly touches the lower face of the belt conveyor (T) with one of its larger faces.

29) Equipment according to claim 26, in which the electrode (12) has approximately the following dimensions: 20×10×65 mm.

30) Equipment according to claim 26, in which there is provided, under the lower run of the electrode conveyor (9) and parallel to it, a fixed guide (14), made from electrically insulating material at least in its upper part and having a curved initial portion (114) for collecting the electrodes leaving the upper run of the corresponding conveyor, this guide having the function of preventing the said electrodes from oscillating in an unnecessary and dangerous way along the return path, and positioning the said electrodes correctly for interaction with a metal brush (15) connected to earth for eliminating any residual voltage on the electrodes before their return to the upper run of the conveyor (9).

31) Equipment according to claim 26, in which each of the electrodes (12) carries on at least one end an integral skid (212) made from electrically insulating material and with a low coefficient of friction, which, during the movement of the electrodes, interacts with guide means which place the said electrodes correctly in the active or passive position in which they contact or do not contact the upper run of the belt conveyor (T) of the painting machine.

32) Equipment according to claim 26, in which a fixed cam in the form of a sector of a circle (16), preferably made from electrically insulating material, is provided coaxially with the return shaft (10′) of the electrode conveyor (9), this cam interacting with the end skids (212) of the said electrodes (12) which, as a result of this interaction, are kept away from the links (109) of the chain of the said conveyor, to ensure that these links have a freedom of relative movement on the curved path around the said shaft.

33) Equipment according to claim 26, in which an inclined plane cam (17) is provided in the initial part of the upper run of the electrode conveyor (9), this cam being transferable by an actuator (18) from a high position to a low position at the command of the processor which controls the operation of the machine and which, additionally acting on the basis of the data received from an optoelectronic barrier (B) or other means which detects the dimensions of the panels (P) on entry into the painting machine and on the basis of data received from a sensor (118) which detects the phase of the electrodes (12), decides whether the said electrodes cyclically reaching the upper position are to be activated or not, and therefore whether the said inclined plane cam is to be in the high or low position respectively.

34) Equipment according to claim 33, in which the initial part, suitably tapered to form a lead-in, of a linear guide (19), preferably made from electrically insulating material, is provided down-line from the movable inclined plane cam (17) when the latter is in the high position, the guide being fixed to the frame of the conveyor in question, parallel to the said conveyor, the end skids (212) of the electrodes (12) rising on to and sliding along the guide and thus being raised and kept in contact with the conveyor belt (T), another fixed guide (19′), also made from electrically insulating material and with a low coefficient of friction, being provided opposite the said guide (19) and parallel thereto, the other ends of the electrodes (12) sliding and bearing directly, or with the interposition of an additional skid, on the guide (19′), and thus advancing with a uniformly distributed and constant contact with the conveyor (T) above them.

35) Equipment according to claim 33, in which, if the said wedge-shaped guide (17) is in the low position, the electrodes (12) advance in the low position, each in contact with a link of the corresponding conveyor (9), in a position suitably distant from the conveyor (T) of the painting machine.

36) Equipment according to claim 26, in which the pivot pins (13) of the levers (112) carrying the electrodes (12) and carrying at their ends the levers (113) for making contact with the linear collector (20) for polarizing the electrodes, are axially movable and each is provided, at the opposite end from the lever (113), with a head (213), and means are provided for changing the position in space of these pins, to ensure that only the lever (13) of each electrode which is to be in the high active position touches the said collector (20), while the lever of each electrode in the low and inactive position follows a path to one side of and distant from the said collector, so that the corresponding electrodes are not polarized.

37) Equipment according to claim 36, characterized in that, before leaving the lower run of the electrode conveyor (9), the end lever (113) of each pivot pin (13) of the said electrodes which has previously left a stage of interaction with the upper collector (20) interacts with a linear fixed cam (21) made from electrically insulating material, which forces the said pin to move axially so that the lever (113) is brought closer to the supporting appendage (209), in such a way that all the levers (113) which are leaving the lower run of the electrode conveyor (9) and which are about to rise to the upper run are positioned on the links (109) of this conveyor and consequently to one side of and distant from the position in space occupied by the said polarization collector (20).

38) Equipment according to claim 37, characterized in that there is provided, in the initial part of the upper run of the electrode conveyor (9), an exchange device (22) which, at the command of the processor, moves axially the pivot pins (13) of only those electrodes (12) which are to remain in the high active position, in such a way that the levers (113) of these pins move along a trajectory of interaction with the linear polarization collector (20).

39) Equipment according to claim 38, in which the exchange device (22) comprises a right-angled lever (122) pivoted on a vertical axis (222) and connected to an oscillation actuator (322) which, when commanded, can move the said lever from the resting position, in which it does not interfere with the pivot pins (13) of the electrodes, to the active position in which one arm of this lever is inclined so that it interferes with the heads (213) of the said pins (13), to subject them to the axial movement which causes the corresponding lever (113) to interact with the linear polarization collector (20) of the electrodes.

40) Equipment according to claim 19, in which the electrodes (E) for polarizing the panels to be painted are fixed on the bed (7) which supports the upper run of the conveyor (T) for advancing the said panels and are positioned at isolated points located one after the other in at least one row whose length is suitably greater than the length of the paint chamber (C) and which is orientated along the longitudinal axis of this chamber.

41) Equipment according to claim 40, in which the row of electrodes (E) can be positioned with a slight inclination in the range from 0° to 15°, for example approximately 7°, with respect to the longitudinal axis of the conveyor (T), in such a way that the said electrodes are arranged progressively in different positions with respect to the edges of the panels, to ensure that the panels are correctly and uniformly covered with paint.

42) Equipment according to claim 40, in which the electrodes (E) can be positioned in different ways on the vertices of a broken line which forms a wave of the alternating type, with the horizontal axes suitably inclined with respect to the longitudinal axis of the conveyor (T), in such a way that the said electrodes are also widely distributed over the width of the said conveyor (T) for advancing the articles to be painted.

43) Equipment according to claim 40, in which the electrodes (E) are suitably spaced apart from each other, for example by distances of approximately 5 to 20 times, for example approximately 10 times, the height of the edges of the panels to be painted.

44) Equipment according to claim 40, in which the electrodes (E) can be made in the form of screws with flat countersunk heads, with hexagonal sockets, and with shanks of suitable diameter, for example in the range from 5 to 15 mm.

45) Equipment according to claim 44, in which the screws forming the electrodes (E) are fixed in holes formed in the bed (7) above which the upper run of the conveyor (T) slides, in such a way that the flat faces of their heads are coplanar with the upper face of the said bed (7).

46) Equipment according to claim 44, in which the screws forming the electrodes (E) are fixed in holes formed in the bed (7) and in the corresponding upper cover (8) above which the upper run of the conveyor (T) slides, in such a way that the flat faces of their heads are essentially in contact with the said conveyor (T) for advancing the panels.

47) Equipment according to claim 40, in which means are provided for ensuring that the electrodes (E) of each row are all constantly connected to the polarization generator.

48) Equipment according to claim 40, characterized in that means are provided for modulating the activation and inactivation of the electrodes (E) of each row in accordance with the variations of the positions above them of the panel to be painted, which moves continuously, in such a way that the said electrodes, in the active phase, are never active at critical distances or too close to the edges of the panels.

49) Equipment according to claim 48, in which the electrodes (E) can be connected to the polarization source (X) through a switching unit (K) controlled by a processor unit (L) which receives from the barrier (B) and from an encoder (G) the data relating to the dimensions and speed and consequently to the position in space of the panels to be painted.

50) Equipment according to claim 49, in which the switching unit (K) comprises switches of the static electronic type.

51) Equipment according to claim 49, in which the switching unit (K) comprises switches of the dynamic type, consisting for example of small cylinder and piston units (27), located under the screws forming the electrodes (E), having their rods aligned and orientated against these screws and holding, with the interposition of an insulating support, an electrical contact (28) connected to the polarization unit (X).

52) Equipment according to claim 40, in which the terminal part (T′) of the conveyor (T) has a downward inclination and continues to be supported by the bed (7, 8), while there is provided above this final inclined portion (101 ) a wedge-shaped conveyor (29) of suitable material, whose upper run is coplanar with and immediately consecutive to the horizontal run of the said conveyor (T) and advances in such a direction and at such a speed that it collects and removes the painted panel.

53) Equipment according to claim 52, in which means are provided to clean the paint from the said wedge-shaped conveyor (29).

54) Equipment according to claim 1, in which the polarization generator (X) of the electrodes (12) can generate a continuous voltage which can vary from 0 to 100 kV, with a useful value, for example, in the region of 60 kV, and with a current measurable in microamperes, for example approximately 500 A.

55) Equipment according to claim 19, characterized in that, since the conveyor belt (T) is very thin and thus relatively elastic, and consequently sensitive to the resistances which it encounters during its advance, which are not balanced and symmetrically distributed, and therefore the said conveyor tends to slip sideways, automatic means are provided to keep it correctly centred and guided on the corresponding return rollers (2, 2′).

56) Equipment according to claim 55, characterized in that the driven end of the conveyor belt (T) of the painting machine runs over a pair of parallel static rollers, one above the other (2′), supported rotatably by the fixed frame (1) of the machine, and over a third roller (102) which forces the conveyor belt to form a re-entrant bend and which is located between the aforesaid rollers (2′) or after the lower roller and is parallel to these, but is mounted rotatably at each end on the intermediate part of a corresponding lever (23) one end of which is pivoted on the said fixed frame (1) and the other end of which is connected to an oscillation actuator (25), of the pneumatic type for example, connected to an operating circuit with the interposition of a unit (26) having a feeler (126) which senses the position in space of the side of the conveyor (T) adjacent to the said lever (23), the whole system being designed in such a way that if the conveyor moves outwards and causes the said feeler (126) to be bent outwards, the unit (26) switches and causes the temporary retraction of the rod of the actuator (25) through a predetermined distance which returns the conveyor (T) to its track, causing a reduction of the force on the feeler (126) and the switching back of the unit (26) which returns the actuator (25) to the resting position.

57) Equipment according to claim 23, characterized in that, if the belt conveyor (T) of the painting machine has a width such that it can accommodate panels which may be of considerable width, where movable electrodes are used, a plurality of conveyors (9) with corresponding electrodes (12) can be positioned side by side and in a parallel arrangement under the upper run of the said conveyor, with a distance between the electrodes of one conveyor and those of the neighbouring conveyor which is not less than that between the electrodes of each conveyor, and/or with the electrodes of one conveyor staggered if necessary with respect to those of the adjacent conveyor, and means are provided for selectively activating these conveyors (9) and/or the corresponding movable electrodes (12) in accordance with the dimensions of the panels to be painted.

58) Equipment according to claim 40, characterized in that, if the belt conveyor (T) of the painting machine has a width such that it can accommodate panels which may be of considerable width, where fixed electrodes are used, a plurality of rows of electrodes (E) can be positioned side by side, with a distance between the electrodes of one row and those of the neighbouring row not less than that between the electrodes of each row, and/or with the electrodes of one row staggered if necessary with respect to those of the adjacent row, and means are provided for selectively activating the rows of fixed electrodes (E) in accordance with the dimensions of the panels to be painted.
